(19) United States
(12) Patent Application Publication
(10) Pub. No.: US 2018/0133077 A1
(43) Pub. Date: May 17, 2018

(54) CHAIR WITH STAND-UP ASSISTANCE

(71) Applicant: Ko-Po Chen, Taichung City (TW)

(72) Inventor: Ko-Po Chen, Taichung City (TW)

(21) Appl. No.: 15/869,059

(22) Filed: Jan. 12, 2018

Related U.S. Application Data
(63) Continuation-in-part of application No. 15/158,613, filed on May 19, 2016.

(51) Int. Cl. A61G 5/14; A47C 1/0355

(52) U.S. Cl. CPC A61G 5/14; A47C 1/0355

(57) ABSTRACT

The chair includes a seat member and an adjustment member. The adjustment member includes a base, a positioning element, first pivot elements, first adjustment elements, each having a first extension segment and a first curved segment, second pivot elements, second adjustment elements, each having a second extension segment and a second curved segment. The chair has the first pivot elements located higher above the second pivot elements so as to create longer lever, greater torque, and steadier adjustment. By synchronizing the first and second adjustment pieces, the chair may be raised in a leveled manner requiring limited leeway.

### CROSS-REFERENCE TO RELATED APPLICATION

This application is a continuation-in-part of U.S. patent application Ser. No. 15/158,613, filed May 19, 2016, the disclosure of which is incorporated herein by reference in its entirety.

### BACKGROUND OF THE INVENTION

### (a) Technical Field of the Invention

The present invention is generally related to chairs with stand-up assistance, and more particular to such a chair providing greater torque and steadiness and requiring less leeway.

### (b) Description of the Prior Art

A chair with stand-up assistance or the so-called lift chair usually allows its user to push the chair so that the chair tilts forward, or assists the user to a standing posture by straightening the knees and moving the body forward.

These conventional chairs have the following drawbacks.

Firstly, the conventional mechanical or power means still require significant user effort in altering the angle of seat or backrest, and chair is shaky in the process, or its steadiness has to be maintained.

Secondly, the chair's movement involves a single axle, or its rotation and linear displacement have to be conducted separately, thereby requiring more leeway.

### SUMMARY OF THE INVENTION

A major objective of the present application therefore is to provide a chair with stand-up assistance having enhanced torque, reduced effort, improved steadiness, lower power, and smaller degree of leeway.

To achieve the objective, 1. A chair with stand-up assistance, comprising a seat member and an adjustment member configured beneath the seat member. The adjustment member includes a base, a positioning element on the base, a pair of first pivot elements at both ends of the positioning element away from the base, respectively, a pair of first adjustment pieces, a pair of second pivot elements configured on the first adjustment pieces, respectively, away from the first pivot elements, and at least a second adjustment piece. Each first adjustment piece is pivotally joined to a first pivot element, and includes a first extension segment connecting the first pivot element, and a first curved segment extended from an end of the first extension segment to provide a longer lever to the first adjustment piece. The second adjustment piece is pivotally joined to a second pivot element, and includes a second extension segment connecting the second pivot element, and a second curved segment extended from an end of the second extension segment to provide a longer lever to the second adjustment piece. The chair in a folded state has the first pivot elements located by the positioning element higher above the second pivot elements so as to create longer lever, greater torque, and steadier adjustment. By synchronizing the first and second adjustment pieces, the chair may be raised in a leveled manner requiring limited leeway.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective diagram showing a chair with stand-up assistance according to a first embodiment of the present invention.

FIG. 2 is a profile diagram showing the chair with stand-up assistance of FIG. 1.

FIG. 3 is a perspective diagram showing a support member of the chair with stand-up assistance of FIG. 1.

FIG. 4 is a profile diagram showing a scenario of the chair with stand-up assistance of FIG. 1.

FIG. 5 is a profile diagram showing another scenario of the chair with stand-up assistance of FIG. 1.

FIG. 6 is a profile diagram showing yet another scenario of the chair with stand-up assistance of FIG. 1.

FIG. 7 is a profile diagram showing the chair with stand-up assistance of FIG. 1 when it is tilted forward.

FIG. 8 is a profile diagram showing a scenario of a chair with stand-up assistance according to a second embodiment of the present invention.

FIG. 9 is a profile diagram showing another scenario of the chair with stand-up assistance of FIG. 8.

FIG. 10 is a profile diagram showing a chair with stand-up assistance according to a third embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

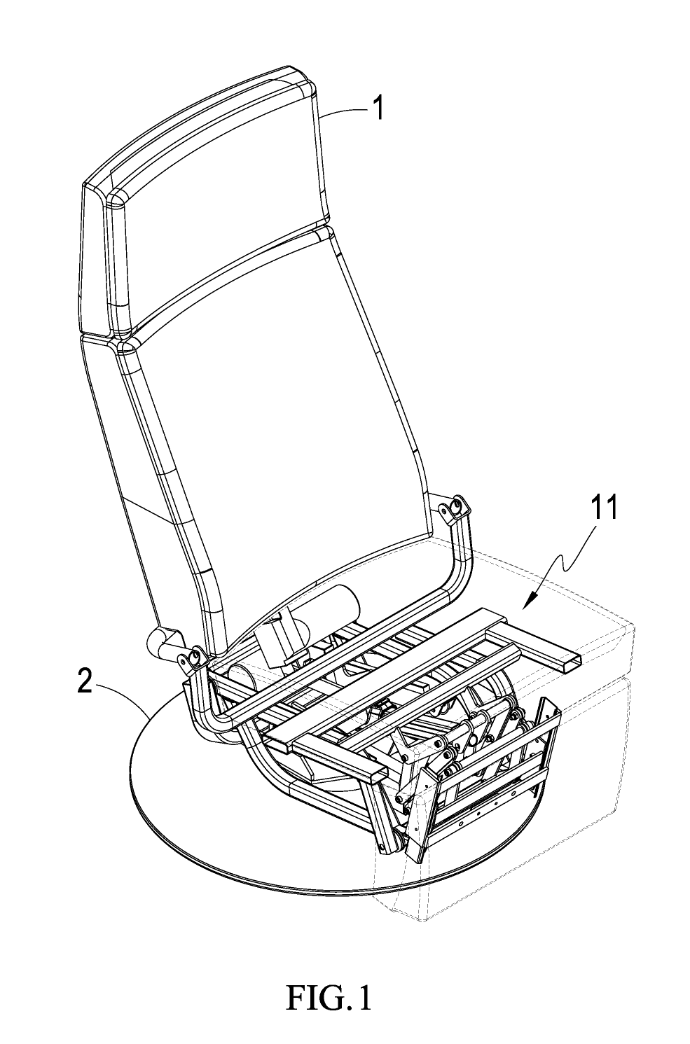

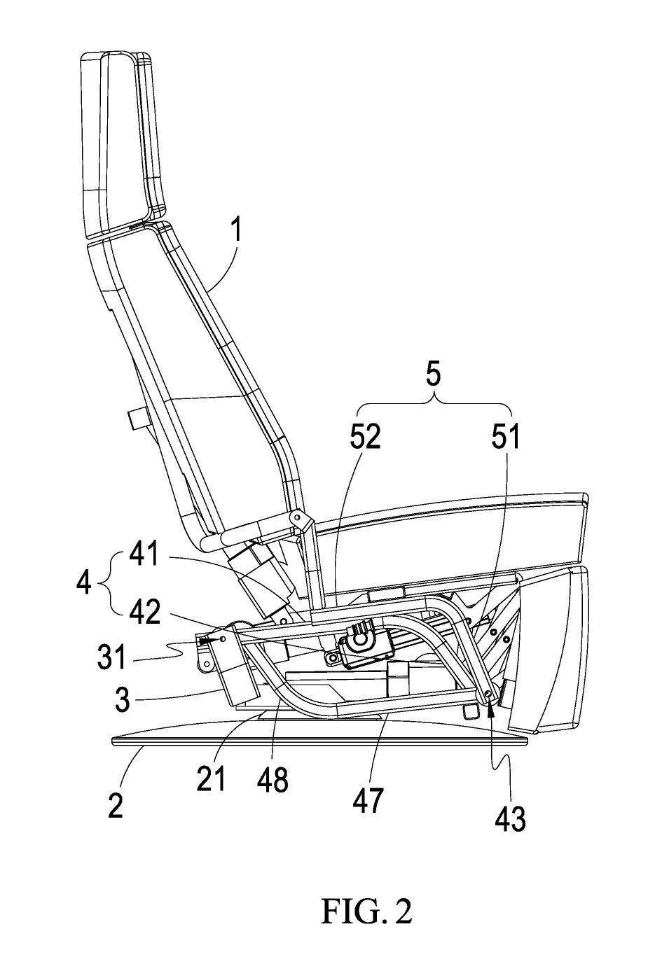

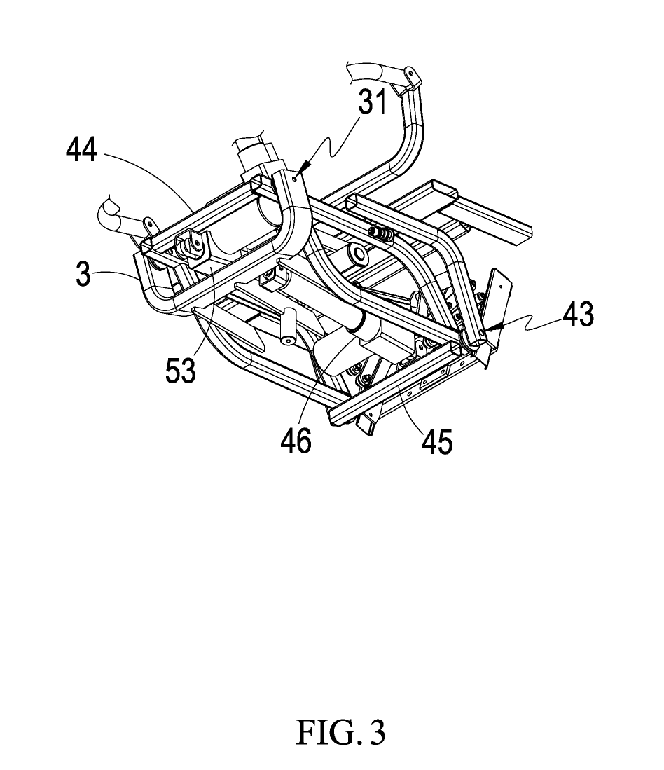

As shown in FIGS. 1 to 3, a chair with stand-up assistance according to a first embodiment of the present invention includes a seat member 1 and an adjustment member 11 configured beneath the seat member 1. The adjustment member 11 includes the following components.

A base 2 includes a swivel 21 on the base 2 for swinging the seat member 1 laterally.

A U-shaped positioning element 3 on the base 2.

A pair of first pivot elements 31 at both ends of the positioning element 3 away from the base 2, respectively.

There is a pair of first adjustment pieces 4, where each is pivotally joined to the first pivot element 31, and includes a first extension segment 41 connecting the first pivot element 31, a first curved segment 42 extended from an end of the first extension segment 41 to provide additional torque to the first adjustment piece 4, a third extension segment 47 connecting a second pivot element 43 (described below), and a third curved segment 48 extended from an end of the third extension segment 47. The first curved segment 42 is joined to the third extension segment 47, and the third curved segment 48 is joined to the first extension segment 41.

There is a pair of second pivot elements 43 configured on the first adjustment pieces 4, respectively, away from the first pivot elements 31, each joining the first curved segment 42 and the third extension segment 47 of a first adjustment pieces 4.

At least a second adjustment piece 5 is pivotally joined to a second pivot element 43, including a second extension segment 51 connecting the second pivot element 43, and a second curved segment 52 extended from an end of the second extension segment 51 to provide additional torque to the second adjustment piece 5.

A first beam 44 has its two ends joins the two first pivot elements 31, respectively, and a second beam 45 has its two ends joins the two second pivot elements 43, respectively. A telescoping first power assembly 46 has an end connected to the positioning element 3 and another end connected to the second beam 45 so that the first power assembly 41 drives the first adjustment pieces 4 to turn counterclockwise around the first pivot elements 31. A telescoping second power assembly 53 has an end connected to the first beam 41 and another end to a bottom side of the seat member 1 so that the second power assembly 53 drives the seat member 1 and the second adjustment piece 5 to turn clockwise around the second pivot elements 43.

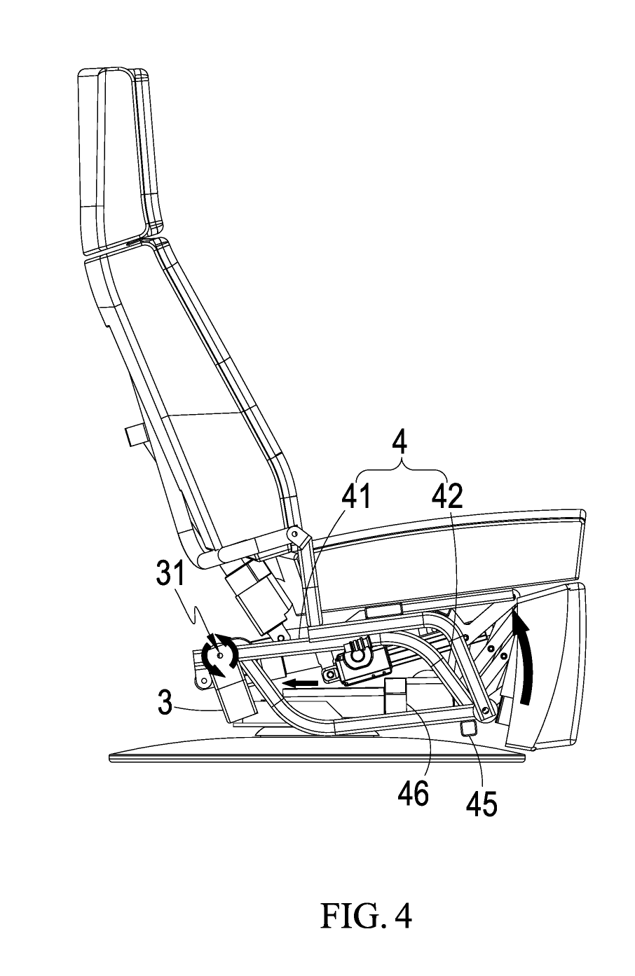

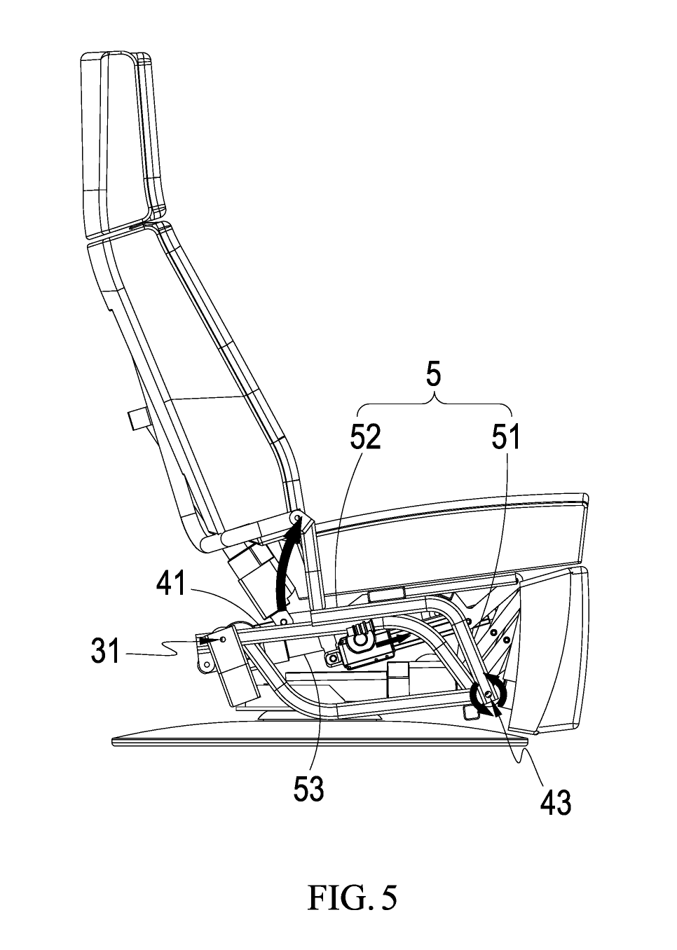

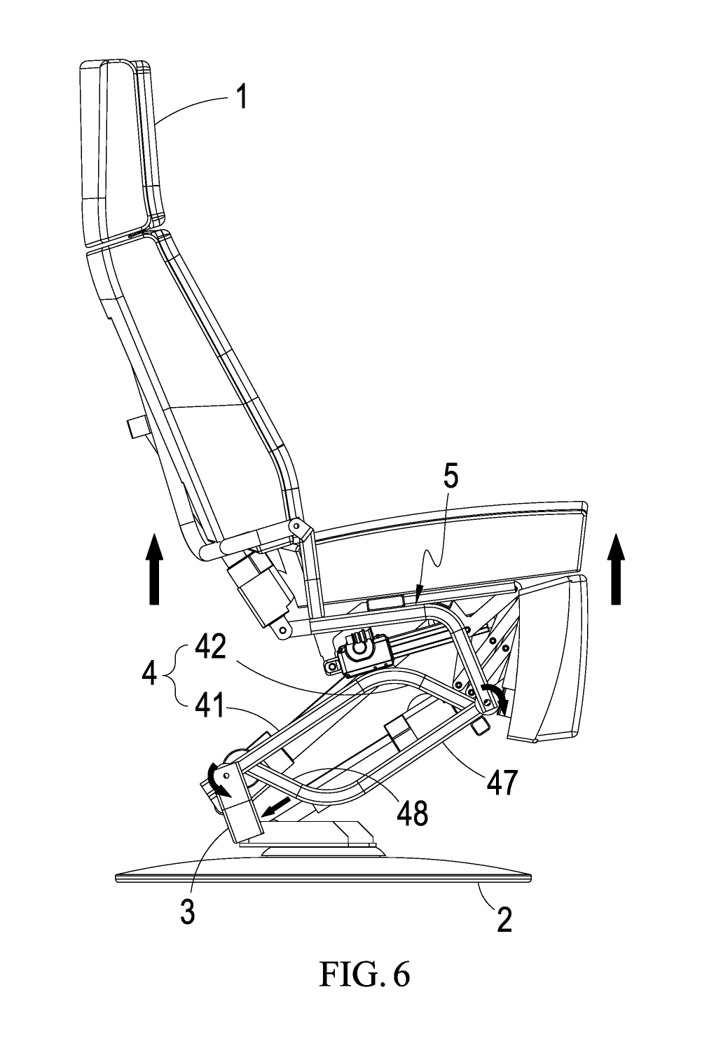

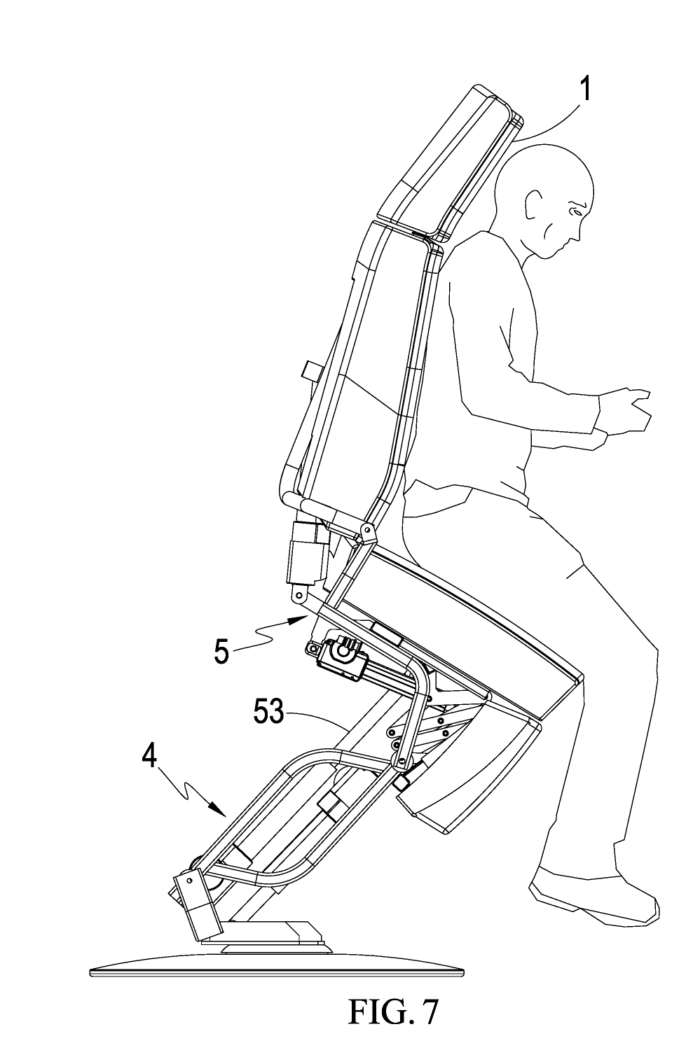

As shown in FIGS. 4 to 7, in addition to provide laterally 360-degree swivel, the present embodiment assist the chair's user to stand up by the adjustment member 11's lifting or turning the seat member 1 through the first and second adjustment pieces 4 and 5.

In a folded state of the present embodiment, the first pivot elements 31 on the positioning element 3 is higher above the second pivot elements 43. The first adjustment pieces 4 pivot around the first pivot elements 31. The first power assembly 46, when extending, pushes the positioning element 3 and the first adjustment pieces 4 turn counterclockwise around the first pivot elements 31 with a torque converted from the push of the first power assembly 46 using the first adjustment pieces 4 as lever. The first and third curved segments 42 and 48 effectively lengthen the length of lever, and therefore a greater torque, so that the present embodiment provides a steadier adjustment.

Similarly, the second adjustment piece 5 pivots around the second pivot elements 43. The second power assembly 53, when extending, pushes the first beam 44 and the second adjustment piece 5 turns clockwise around the second pivot elements 43 with a torque converted from the push of the second power assembly 53 using the second adjustment piece 5 as lever. The second curved segment 52 effectively lengthens the length of lever, and therefore a greater torque, so that the present embodiment provides a steadier adjustment.

The first extension and curved segments 41 and 42, and the second adjustment piece 5 are roughly L-shaped and they can be accommodated underneath the seat member 1, taking up only limited space without interfering each other. The first extension and curved segments 41 and 42, and the third extension and curved segments 47 and 48, jointly form a parallelogram for enhanced structural strength. By synchronizing the first and second adjustment pieces 4 and 5, the sear member 1 may be raised in a leveled manner and the present embodiment would only require limited leeway to operate. Then, as the seat member 1 reaches a desired height, the second power assembly 53 may tilt the seat member 1 forward so as to assist the user to stand up.

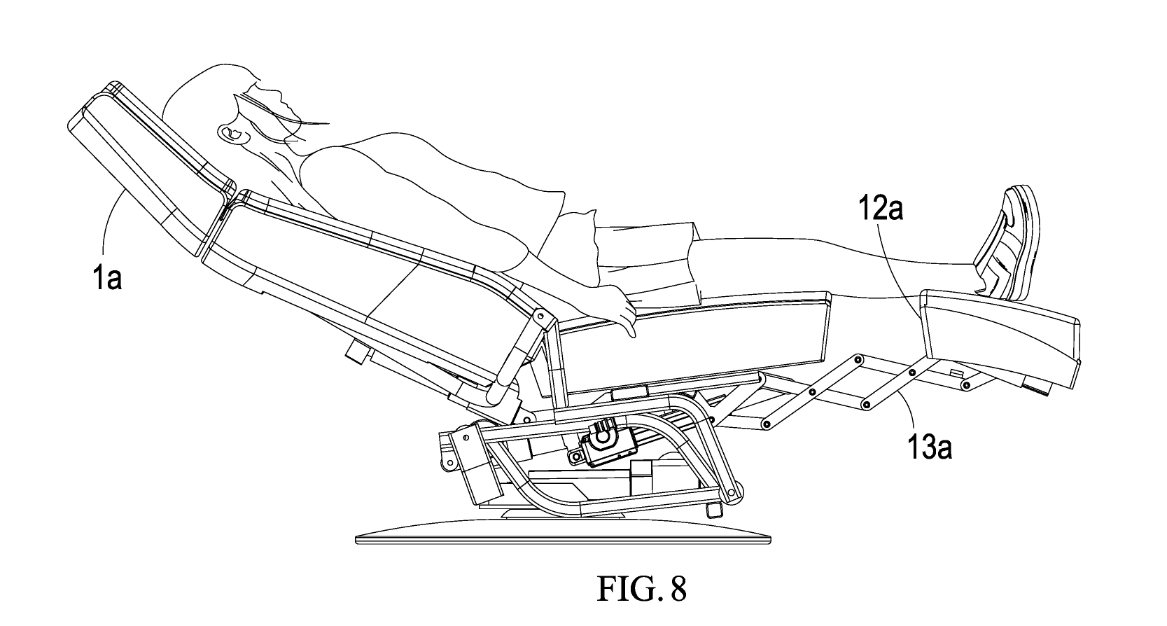

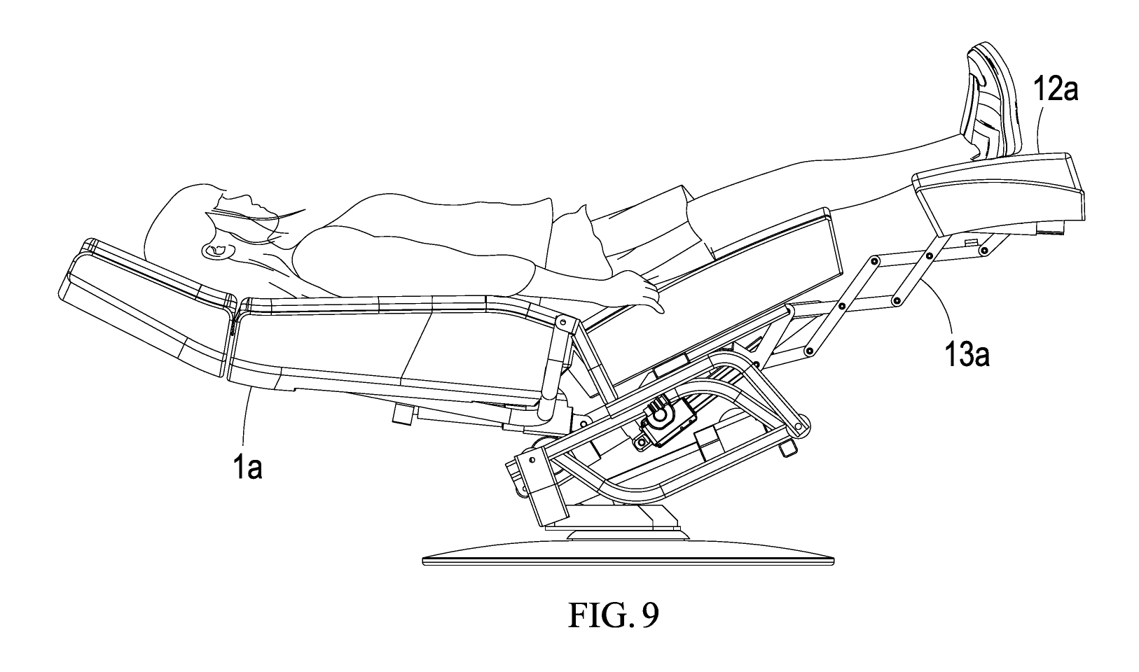

As shown in FIGS. 8 and 9, a second embodiment of the present invention is basically identical to the first embodiment except that the seat member 1a includes a leg rest 12a that may be extended forward from the seat member 1a by an extensible piece 13a such as a scissor arm. As such, a user of the present embodiment may lay almost horizontally on the seat member 1a, as illustrated in FIG. 8. When the seat member 1a is tilted further backward by the adjustment member 11, as illustrated in FIG. 9, the user may lay in the Trendelenburg position so as achieve a zero-gravity effect and to improve blood flow to the brain.

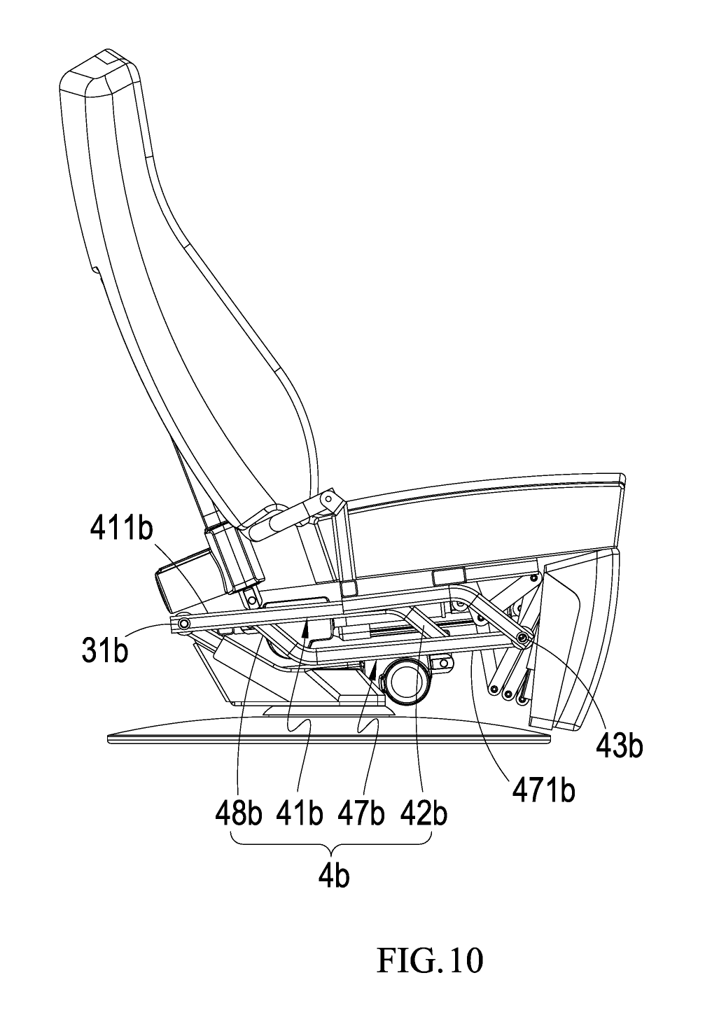

As shown in FIG. 10, a third embodiment of the present invention is basically identical to the previous embodiments except that a first additional extension segment 411b between the first pivot element 31b and the first extension segment 41b, a third additional extension segment 471b between the second pivot element 43b and the third extension segment 47b. As such the first curved segment 42b and the third curved segment 48b are shorter, and the first adjustment piece 4b now has a more elongated shape and a smaller dimension. The appearance would be more visually appealing, and the interference between parts is further reduced.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A chair with stand-up assistance, comprising a seat member and an adjustment member configured beneath the seat member, wherein the adjustment member comprises:
a base;
a positioning element on the base;
a pair of first pivot elements at both ends of the positioning element away from the base, respectively;
a pair of first adjustment pieces, where each is pivotally joined to a first pivot element, and comprises a first extension segment connecting the first pivot element, and a first curved segment extended from an end of the first extension segment to provide a longer lever to the first adjustment piece;
a pair of second pivot elements configured on the first adjustment pieces, respectively, away from the first pivot elements;
at least a second adjustment piece pivotally joined to a second pivot element, comprising a second extension segment connecting the second pivot element, and a second curved segment extended from an end of the second extension segment to provide a longer lever to the second adjustment piece.

2. The chair according to claim 1, wherein the adjustment member further comprises a first beam having both ends joined to the two first pivot elements, respectively, and a second beam having both ends joined to the two second pivot elements, respectively.

3. The chair according to claim 2, wherein each first adjustment piece further comprises a first power assembly having an end connected to the second beam so as to turn the first adjustment piece counterclockwise around the first pivot elements.

4. The chair according to claim 2, wherein the second adjustment piece further comprises a second power assembly has an end connected to the first beam so as to turn the second adjustment piece clockwise around the second pivot elements.

5. The chair according to claim 1, wherein the base comprises a swivel for swiveling the seat member laterally.

6. The chair according to claim 1, wherein each first adjustment piece further comprises a third extension segment connecting the second pivot element, and a third curved segment extended from an end of the third extension segment; the first curved segment is joined to the third extension segment; and the third curved segment is joined to the first extension segment.

7. The chair according to claim 6, wherein each first adjustment piece further comprises a first additional extension segment between the first pivot element and the first extension segment; and a third additional extension segment between the second pivot element and the third extension segment.

8. The chair according to claim 1, wherein the seat member comprises a leg rest extensible forward from the seat member by an extensible piece.

9. The chair according to claim 1, wherein the first pivot elements are located by the positioning element higher above the second pivot elements when the chair is in a folded manner.
